(19) United States
(12) Patent Application Publication
(10) Pub. No.: US 2026/0300492 A1
(43) Pub. Date: Oct. 1, 2026

(54) SELF-SECURED MULTI-LAYER INTELLIGENT OPERATING SYSTEM FOR AUTOMATICALLY CONTROLLING INSTALLATION AND PATCHING OF SOFTWARE APPLICATIONS

(71) Applicant: BANK OF AMERICA CORPORATION, Charlotte, NC (US)

(72) Inventors: Vinod Maghnani, Gurugram (IN); N. Tulasi Bhavani, Hyderabad (IN); Jaya L. Eripilla, Little Elm, TX (US); Amit Mehndiratta, New Delhi (IN); Chetan Singh Naruka, Gurugram (IN); Vijayakumar Surisetti, Chennai (IN)

(73) Assignee: BANK OF AMERICA CORPORATION, Charlotte, NC (US)

(21) Appl. No.: 19/089,602

(22) Filed: Mar. 25, 2025

(51) Int. Cl. G06F 21/57; G06F 8/61

(52) U.S. Cl. CPC G06F 21/572; G06F 8/61

(57) ABSTRACT

Embodiments of the present invention provide a system for automatically controlling installation and patching of software applications. The system is configured to collect data associated with software applications installed entity systems of an entity, analyze the data associated with the software applications to determine one or more actions, execute the one or more actions in one or more containers, determine that the one or more actions result in optimization of the entity systems, validate implementation of real-time execution of the one or more actions on the entity systems, in response to successful validation, generate a Decentralized Non-Fungible Core Token (DNFCT) based smart contract for implementation of the real-time execution associated with each of the one or more actions, and implement the real-time execution of the one or more actions on the entity systems based on the DNFCT based smart contract.

### BACKGROUND

There exists a need for a system that automatically control installation, patching, and updating of software applications associated with an entity.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for automatically controlling installation and patching of software applications. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention collects data associated with one or more software applications associated with an entity that are installed on one or more entity systems, analyzes the data associated with the one or more software applications to determine one or more actions, executes the one or more actions in one or more containers, determines that the one or more actions result in optimization of the one or more entity systems, validates implementation of real-time execution of the one or more actions on the one or more entity systems, determines that the validation associated with the implementation of the real-time execution of the one or more actions on the one or more entity systems is successful, in response to successfully validating the implementation of the real-time execution of the one or more actions in real-time, generates a Decentralized Non-Fungible Core Token (DNFCT) based smart contract for implementation of the real-time execution associated with each of the one or more actions, and implements the real-time execution of the one or more actions on the one or more entity systems based on the DNFCT based smart contract.

In some embodiments, the present invention analyzes the one or more actions across the one or more software applications, dynamically generates a weightage associated with the one or more actions based on analyzing the one or more actions across the one or more software applications, and assigns the weightage to the DNFCT based smart contract corresponding to the one or more actions.

In some embodiments, the present invention identifies other entity applications having similar characteristics of the one or more software applications and recommends the one or more actions for the other entity applications based on the weightage assigned to the DNFCT based smart contract corresponding to the one or more actions.

In some embodiments, the present invention generates the weightage based on one or more parameters associated with the one or more actions, wherein the one or more parameters comprise at least technology information, program code, and performance information associated with the one or more actions.

In some embodiments, the DNFCT based smart contract comprises one or more rules associated with the implementation of the real-time execution of the one or more actions on the one or more entity systems.

In some embodiments, validating the implementation of the real-time execution of the one or more actions on the one or more entity systems comprises implementing a consensus mechanism by communicating with a plurality of validators associated with the one or more entity systems to provide a decision associated with the implementation of the real-time execution of the one or more actions on the one or more entity systems, receiving a plurality of decisions from the plurality of validators, and validating the implementation of the real-time execution of the one or more actions on the one or more entity systems based on the plurality of decisions.

In some embodiments, the consensus mechanism is a Federated Byzantine Agreement (FBA).

In some embodiments, the one or more actions comprise at least one of installation of a latest patch associated with the one or more software applications, uninstallation of a previously installed patch associated with the one or more software applications, uninstallation of the one or more software applications, and installation of a new software application.

In some embodiments, the data associated with the one or more entity applications comprises at least installed software applications, package versions, system libraries, and security patches.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for automatically controlling installation and patching of software applications, in accordance with an embodiment of the invention;

FIG. 2 provides a block diagram illustrating the entity system(s) 200 of FIG. 1, in accordance with an embodiment of the invention;

FIG. 3 provides a block diagram illustrating an automatic application installation and patching system 300 of FIG. 1, in accordance with an embodiment of the invention;

FIG. 4 provides a block diagram illustrating the computing device system 400 of FIG. 1, in accordance with an embodiment of the invention;

FIG. 5 provides a process flow for automatically controlling installation and patching of software applications, in accordance with an embodiment of the invention; and

FIG. 6 provides a block diagram illustrating multiple layers of a self-secured multi-layer intelligent operating system for the entity systems 200 provided by the automatic application installation and patching system 300 for automatically controlling installation and patching of the software applications in the entity systems 200, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be any organization that utilizes one or more entity resources (e.g., employees, software resources, hardware resources, and/or the like) to perform one or more activities associated with the entity. In some embodiments, the entity may be a financial institution which may include herein may include any financial institutions such as commercial banks, thrifts, federal and state savings banks, savings and loan associations, credit unions, investment companies, insurance companies and the like. In some embodiments, the entity may be a non-financial institution. As described herein, a “user” may be an employee, a customer, or a potential customer of the entity.

Many of the example embodiments and implementations described herein contemplate interactions engaged in by a user with a computing device and/or one or more communication devices and/or secondary communication devices. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

“Distributed register,” as used herein may also be referred to as a “distributed ledger,” as used herein may refer to a structured list of data records that is decentralized and distributed amongst a plurality of computing systems and/or devices. In some embodiments, the distributed ledger may use a linked block structure.

“Linked block,” “linked block structure,” “linked structure,” or “blockchain” as used herein may refer to a data structure which may comprise a series of sequentially linked “blocks,” where each block may comprise data and metadata. The “data” within each block may comprise one or more “data record” or “transactions,” while the “metadata” within each block may comprise information about the block, which may include a timestamp, a hash value of data records within the block, a pointer (e.g., a hash value) to the previous block in the linked block structure, and/or any additional data created by the system of the present invention. In this way, beginning from an originating block (e.g., a “genesis block”), each block in the linked block structure is linked to another block via the pointers within the block headers. If the data or metadata within a particular block in the linked block structure becomes corrupted or modified, the hash values found in the header of the affected block and/or the downstream blocks may become mismatched, thus allowing the system to detect that the data has been corrupted or modified. In some embodiments of the present invention, a user may submit data associated with the creation of a new block associated with the linked block structure. For example, a user may initiate a transaction, where the data associated with the transaction is stored in a new block linked with the transaction.

A “linked block ledger” may refer to a distributed ledger which uses linked block data structures. Generally, a linked block ledger is an “append only” ledger in which the data within each block within the linked block ledger may not be modified after the block is added to the linked block ledger; data may only be added in a new block to the end of the linked block ledger. In this way, the linked block ledger may provide a practically immutable ledger of data records over time.

“Permissioned distributed ledger” as used herein may refer to a linked block ledger for which an access control mechanism is implemented such that only known, authorized users may take certain actions with respect to the linked block ledger (e.g., add new data records, participate in the consensus mechanism, or the like). Accordingly, “unpermissioned distributed ledger” as used herein may refer to a linked block ledger without an access control mechanism.

“Private distributed ledger” as used herein may refer to a linked block ledger accessible only to users or devices that meet specific criteria (e.g., authorized users or devices of a certain entity or other organization). Accordingly, a “public distributed ledger” is a linked block ledger accessible by any member or device in the public realm. In some embodiments of the present invention, the distributed ledger being described herein may be a permissioned distributed ledger. In some embodiments of the present invention, the distributed ledger being described herein may be a private distributed ledger.

“Node” as used herein may refer to a computing system on which the distributed ledger is hosted. In some embodiments, each node maintains a full copy of the distributed ledger. In this way, even if one or more nodes become unavailable or offline, a full copy of the distributed ledger may still be accessed via the remaining nodes in the distributed ledger system. That said, in some embodiments, the nodes may host a hybrid distributed ledger such that certain nodes may store certain segments of the linked block ledger but not others.

“Consensus,” “consensus algorithm,” or “consensus mechanism” as used herein may refer to the process or processes by which nodes come to an agreement with respect to the contents of the distributed ledger. Changes to the ledger (e.g., addition of data records) may require consensus to be reached by the nodes in order to become a part of the authentic version of the ledger. In this way, the consensus mechanism may ensure that each node maintains a copy of the distributed ledger that is consistent with the copies of the distributed ledger hosted on the other nodes; if the copy of the distributed ledger hosted on one node becomes corrupted or compromised, the remaining nodes may use the consensus algorithm to determine the “true” version of the distributed ledger. The nodes may use various different mechanisms or algorithms to obtain consensus, such as proof-of-work (“PoW”), proof-of-stake (“PoS”), practical byzantine fault tolerance (“PBFT”), proof-of-authority (“PoA”), or the like.

“Smart contract” as used herein may refer to executable computer code or logic that may be executed according to an agreement between parties upon the occurrence of a condition precedent (e.g., a triggering event such as the receipt of a proposed data record). In some embodiments, the smart contract may be self-executing code that is stored in the distributed ledger, where the self-executing code may be executed when the condition precedent is detected by the system on which the smart contract is stored.

In accordance with embodiments of the invention, Non-Fungible Tokens (NFTs), may be a unit of data used a unique digital identifier stored on a distributed register that certifies ownership and authenticity of a digital artifact (e.g., program code associated with one or more actions, in accordance with embodiments of the present invention). As such, NFTs are stored in a distributed ledger-a database that is consensually shared and synchronized across multiple sites, institutions, or geographies, accessible by multiple people. Distributed ledgers use independent computers (referred to as nodes) to record, share and synchronize transactions in their respective electronic ledgers (instead of keeping data centralized as in a traditional ledger). In accordance with embodiments of the present invention, NFTs are created when a distributed ledger (e.g., blockchain) string records of cryptographic hash, a set of characters that verifies a set of data to be unique, onto previous records therefore creating a chain of identifiable data artifacts.

Typically, entity systems associated with an entity require updates to keep pace with technological advancements. Currently, the update process involves a series of steps, where missing any step may prevent the entity system from being updated, thereby increasing the exposure of security vulnerabilities. Additionally, the installation of updates, software applications, or patches is currently handled in a way that hardcodes the installation path, creating an opportunity for unauthorized users to take advantage of this specific path to introduce malware. As a result, there is a clear need for a system that automates the installation, upgrade, and patching processes while preventing the hardcoding of software installation paths. The system described in the present invention addresses these challenges, as detailed below.

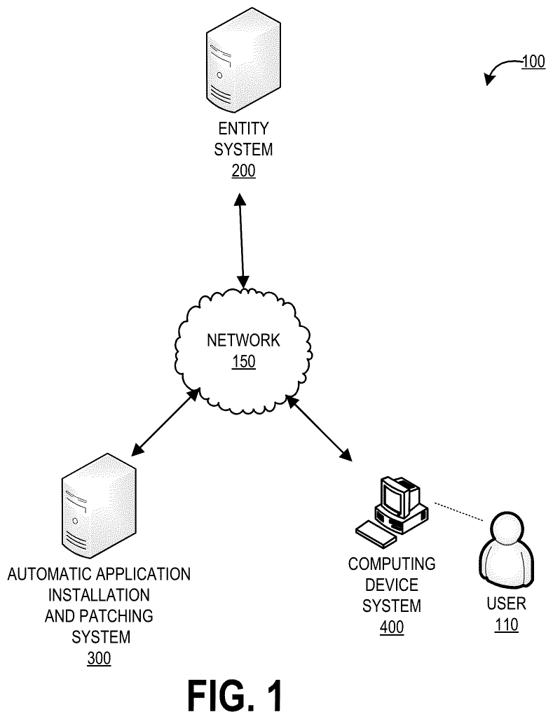

FIG. 1 provides a block diagram illustrating a system environment 100 for automatically controlling installation and patching of software applications, in accordance with an embodiment of the invention. As illustrated in FIG. 1, the environment 100 includes an automatic application installation and patching system 300, an entity system 200, and a computing device system 400. One or more users 110 may be included in the system environment 100, where the users 110 interact with the other entities of the system environment 100 via a user interface of the computing device system 400. In some embodiments, the one or more users 110 may be employees of the entity associated with the entity system 200.

The entity system(s) 200 may be any system owned or otherwise controlled by an entity to support or perform one or more process steps described herein. In some embodiments, the entity may be any organization that utilizes one or more entity resources for performing one or more activities associated with the entity. In some embodiments, the entity is a financial institution. In some embodiments, the entity is a non-financial institution. In some embodiments, the one or more software applications may be developed by the entity resources to perform the one or more activities. In some embodiments, the entity systems 200 may be decentralized entity systems.

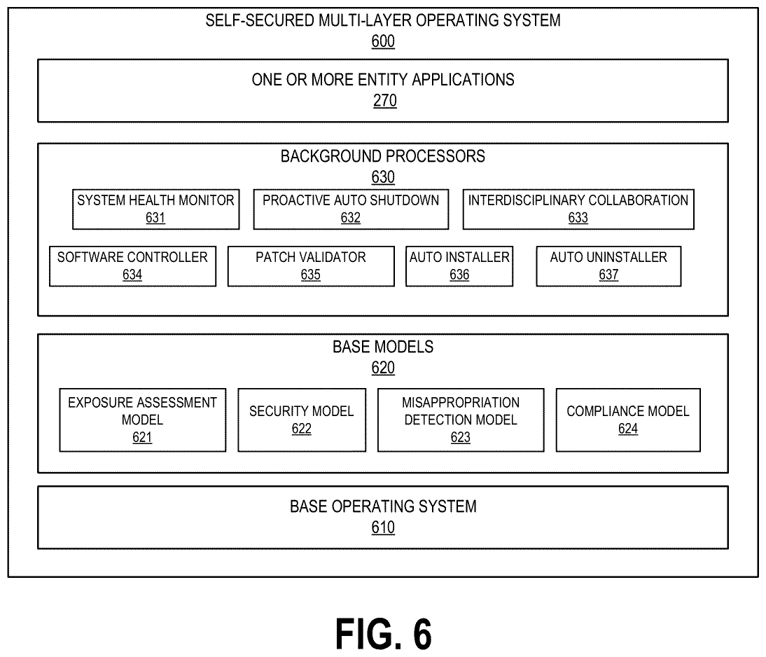

The automatic application installation and patching system 300 is a system of the present invention for performing one or more process steps described herein. In some embodiments, the automatic application installation and patching system 300 may be an independent system. In some embodiments, the automatic application installation and patching system 300 may be a part of the entity system 200. In some embodiments, the automatic application installation and patching system 300 may provide a self-secured multi-layered operating system (as shown in FIG. 6) for the entity systems 200 that allows for automatically controlling application installation, patching, and upgrades. In some such embodiments, the self-secured multi-layered operating system may be an additional layer to the existing operating systems of the entity systems 200. In some embodiments, the automatic application installation and patching system 300 may be controlled, owned, managed, and/or maintained by the entity associated with the entity system 200.

The automatic application installation and patching system 300, the entity system 200, and the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the automatic application installation and patching system 300 is configured to communicate information or instructions with the entity system 200, and/or the computing device system 400 across the network 150.

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the automatic application installation and patching system 300, and/or entity system 200 across the network 150.

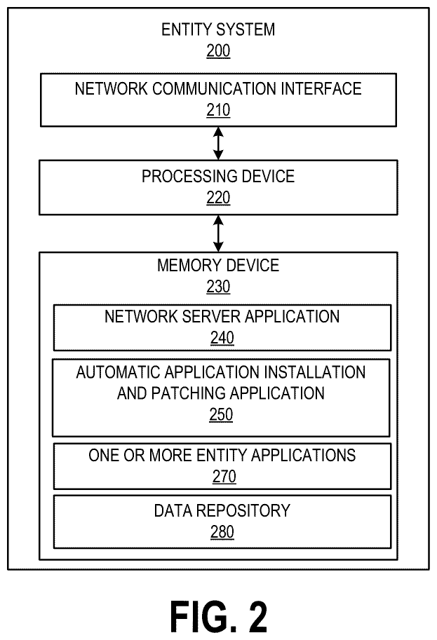

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution or a non-financial institution.

It should be understood that the memory device 230 may include one or more databases or other data structures/repositories. The memory device 230 also includes computer-executable program code that instructs the processing device 220 to perform one or more processing functionalities described herein and also to operate the network communication interface 210 to perform certain communication functions of the entity system 200 described herein. For example, in one embodiment of the entity system 200, the memory device 230 includes, but is not limited to, an automatic application installation and patching application 250, one or more entity applications 270, and a data repository 280. The one or more entity applications 270 may be any applications developed, supported, maintained, utilized, and/or controlled by the entity. The computer-executable program code of the network server application 240, the automatic application installation and patching application 250, the one or more entity application 270 to perform certain logic, data-extraction, and data-storing functions of the entity system 200 described herein, as well as communication functions of the entity system 200.

The network server application 240, the automatic application installation and patching application 250, and the one or more entity applications 270 are configured to store data in the data repository 280 or to use the data stored in the data repository 280 when communicating through the network communication interface 210 with the automatic application installation and patching system 300, and/or the computing device system 400 to perform one or more process steps described herein. In some embodiments, the entity system 200 may receive instructions from the automatic application installation and patching system 300 via the automatic application installation and patching application 250 to perform certain operations. The automatic application installation and patching application 250 may be provided by the automatic application installation and patching system 300. The one or more entity applications 270 may be any of the applications used, created, modified, facilitated, developed, and/or managed by the entity system 200.

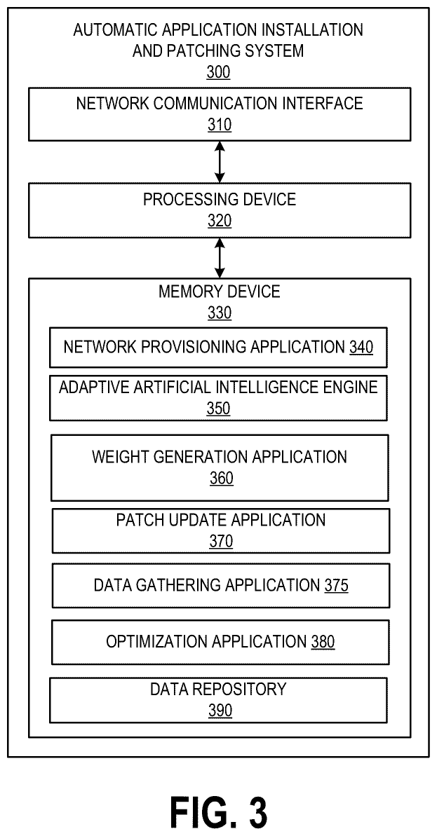

FIG. 3 provides a block diagram illustrating the automatic application installation and patching system 300 in greater detail, in accordance with embodiments of the invention. As illustrated in FIG. 3, in one embodiment of the invention, the automatic application installation and patching system 300 includes one or more processing devices 320 operatively coupled to a network communication interface 310 and a memory device 330. In certain embodiments, the automatic application installation and patching system 300 is operated by an entity, such as a financial institution. In some embodiments, the automatic application installation and patching system 300 is owned or operated by the entity of the entity system 200. In some embodiments, the automatic application installation and patching system 300 may be an independent system. In alternate embodiments, the automatic application installation and patching system 300 may be a part of the entity system 200.

It should be understood that the memory device 330 may include one or more databases or other data structures/repositories. The memory device 330 also includes computer-executable program code that instructs the processing device 320 to perform processing operations described herein and to operate the network communication interface 310 to perform certain communication functions of the automatic application installation and patching system 300. For example, in one embodiment of the automatic application installation and patching system 300, the memory device 330 includes, but is not limited to, a network provisioning application 340, an adaptive artificial intelligence engine 350, a weight generation application 360, a patch update application 370, a data gathering application 375, an optimization application 380, and a data repository 390 comprising any data processed or accessed by one or more applications in the memory device 330. The computer-executable program code of the network provisioning application 340, the adaptive artificial intelligence engine 350, the weight generation application 360, the patch update application 370, the data gathering application 375, and the optimization application 380 may instruct the processing device 320 to perform certain logic, data-processing, and data-storing functions of the automatic application installation and patching system 300 described herein, as well as communication functions of the automatic application installation and patching system 300.

The network provisioning application 340, the adaptive artificial intelligence engine 350, the weight generation application 360, the patch update application 370, the data gathering application 375, and the optimization application 380 are configured to invoke or use the data in the data repository 390 when communicating through the network communication interface 310 with the entity system 200, and/or the computing device system 400. In some embodiments, the network provisioning application 340, the adaptive artificial intelligence engine 350, the weight generation application 360, the patch update application 370, the data gathering application 375, and the optimization application 380 may store the data extracted or received from the entity system 200, and the computing device system 400 in the data repository 390. In some embodiments, the network provisioning application 340, the adaptive artificial intelligence engine 350, the weight generation application 360, the patch update application 370, the data gathering application 375, and the optimization application 380 may be a part of a single application (e.g., modules).

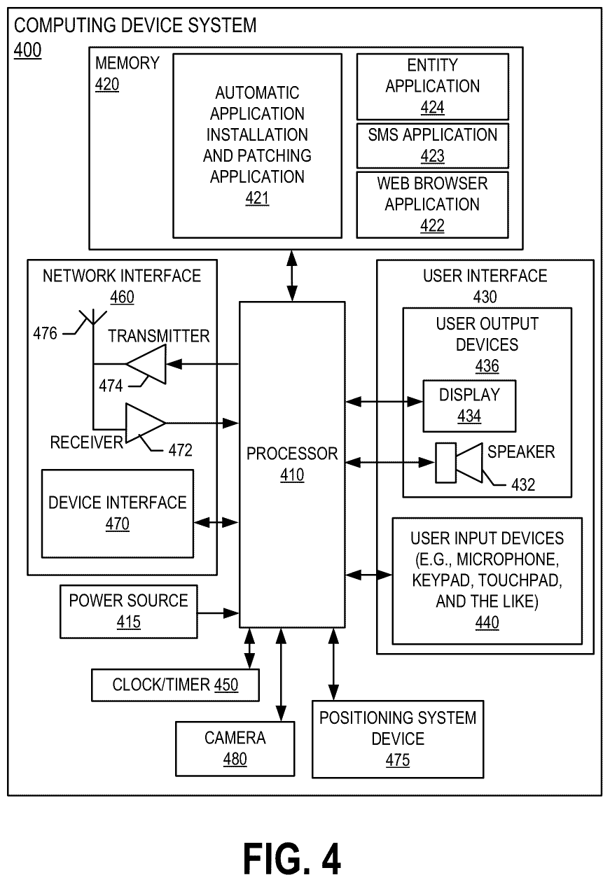

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, an automatic application installation and patching application 421, entity application 424. These applications also typically instructions to a graphical user interface (GUI) on the display 430 that allows the user 110 to interact with the entity system 200, the automatic application installation and patching system 300, and/or other devices or systems. The memory 420 of the computing device system 400 may comprise a Short Message Service (SMS) application 423 configured to send, receive, and store data, information, communications, alerts, and the like via the wireless network. In some embodiments, the automatic application installation and patching application 421 provided by the automatic application installation and patching system 300 allows the user 110 to access the automatic application installation and patching system 300. In some embodiments, the entity application 424 provided by the entity system 200 and the automatic application installation and patching application 421 allow the user 110 to access the functionalities provided by the automatic application installation and patching system 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

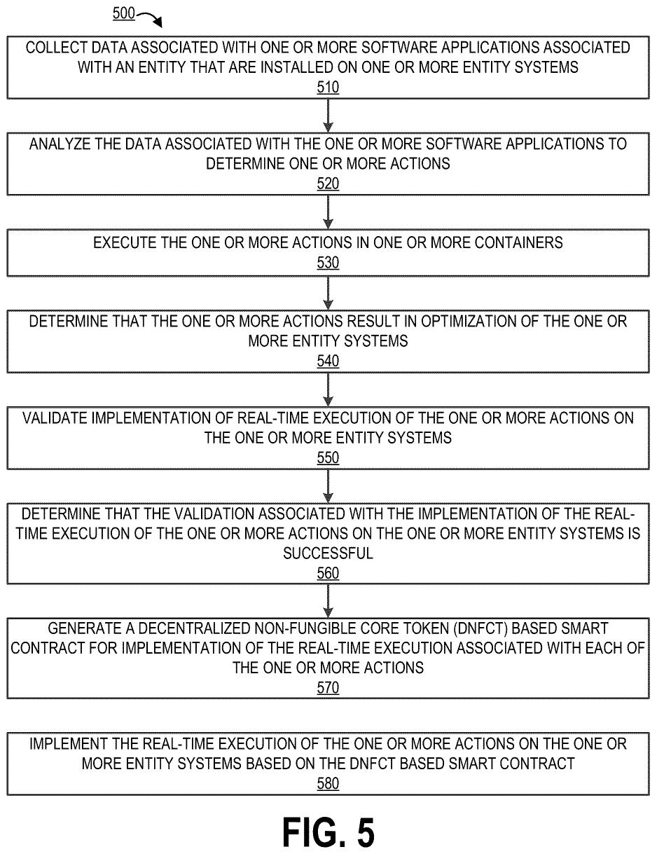

FIG. 5 provides a flowchart 500 illustrating a process flow for automatically controlling installation and patching of software applications, in accordance with an embodiment of the invention.

As shown in block 510, the system collects data associated with one or more software applications associated with an entity that are installed on one or more entity systems. The data collected by the system may comprise at least installed software applications, package versions, system libraries, and security patches. In some embodiments, the system may collect the data at predefined intervals. In some embodiments, the system may collect the data upon identifying a security vulnerability. In some embodiments, the system may collect the data upon identifying the need to implement one or more actions as described below.

As shown in block 520, the system analyzes the data associated with the one or more software applications to determine one or more actions. In some embodiments, the system may use artificial intelligence model to analyze the data. The one or more actions may comprise at least one of installation of a latest patch associated with the one or more software applications, uninstallation of a previously installed patch associated with the one or more software applications, uninstallation of the one or more software applications, and installation of a new software application.

Analyzing the data associated with the one or more software applications may determine whether there is a need for the one or more actions. For example, the system may identify a security vulnerability and the system may analyze the data to determine if the one or more software applications and the one or more entity systems are protected from the security vulnerability. If the system determines that the one or more software applications or the one or more entity systems are not protected from the vulnerability, the system may implement the one or more actions to mitigate exposure associated with the security vulnerability.

As shown in block 530, the system executes the one or more actions in one or more containers. In some embodiments, the one or more containers may be containers on a development environment, testing environment, Quality Assurance environment, and/or any other environment before executing the one or more actions in real-time production environment. In some embodiments, the system may execute the one or more actions in containers of all of the development environment, testing environment, and quality assurance environment consecutively. In some embodiments, the one or more actions move from one container to another container across different environments (e.g., development environment, testing environment, quality assurance environment, and/or the like).

As shown in block 540, the system determines that the one or more actions result in optimization of the one or more entity systems. The system, based on executing the one or more actions in the one or more containers in the development environment, testing environment, and quality assurance environment, the system may determine whether the optimization of the one or more entity systems is achieved or not, where the optimization may be associated with safeguarding against security vulnerabilities, improving functioning of the entity systems, improving processing capabilities of the entity systems, improving efficiency of the one or more software applications installed on the entity systems, and/or the like.

As shown in block 550, the system validates implementation of real-time execution of the one or more actions on the one or more entity systems. In some embodiments, the system before moving the execution of the one or more actions from the containers in pre-production environments to the production environment, the system performs validation whether the one or more actions should be implemented or not. The system may perform the validation based on implementing a consensus mechanism. In some embodiments, the consensus mechanism may comprise communicating with a plurality of validators associated with the one or more entity systems to provide a decision associated with the implementation of the real-time execution of the one or more actions on the one or more entity systems, receiving a plurality of decisions from the plurality of validators, and validating the implementation of the real-time execution of the one or more actions on the one or more entity systems based on the plurality of decisions. In some embodiments, the plurality of validators may be any stakeholders that are associated with the one or more software applications or the one or more entity systems. Examples of the plurality of validators may comprise application owners, product owners, development team, quality assurance team, and/or the like. In some embodiments, the system may also provide one or more rules (e.g., clauses) associated with the implementation of the one or more actions, where the one or more rules may be set by the entity. In some embodiments, the decision rights for each of the plurality of the stakeholders may be dynamically determined by the system based on a type of the one or more actions. For example, for a first action, the system may dynamically assign 40% decision right to the application owner, 10% decision right to the product owner, 30% decision right to the development team, and 20% decision right to the quality assurance team. In another example, for a second action, the system may dynamically assign 25% decision right to the application owner, 25% decision right to the product owner, 25% decision right to the development team, and 25% decision right to the quality assurance team. In some embodiments, the system may use a Federated Byzantine Agreement consensus mechanism for validating whether the one or more actions should be executed or not on the entity systems.

As shown in block 560, the system determines that the validation associated with the implementation of the real-time execution of the one or more actions on the one or more entity systems is successful. The system may determine that the validation is successful or unsuccessful based on determining that the plurality of decisions are associated with approval or rejection respectively.

As shown in block 570, the system generates a Decentralized Non-Fungible Core Token (DNFCT) based smart contract for implementation of the real-time execution associated with each of the one or more actions. The DNFCT smart contract may be a distributed register (e.g., blockchain) based smart contract that involves creating a smart contract on a decentralized system/distributed register system and unique Non-Fungible Token that represents program code associated with the one or more actions. In some embodiments, the DNFCT smart contract may also incorporate the results of the consensus mechanism explained above. The system may generate a DNFCT smart contract for every action of the one or more actions. The system may generate a DNFCT smart contract based on the one or more rules set by the entity (e.g., the smart contract can only be implemented when there 100% consensus from the plurality of validators).

As shown in block 580, the system implements the real-time execution of the one or more actions on the one or more entity systems based on the DNFCT based smart contract. The system may move the one or more actions from the containers in pre-production environments to the production environment based on the DNFCT smart contract. The system may identify idle resources and idle time slots in the production server to implement the real-time execution of the one or more actions on the one or more entity systems in production environment. In some embodiments, the system may dynamically create a container in the production environment for implementing the real-time execution of the one or more actions on the one or more entity systems. Dynamically creating a container and executing the one or more actions may result in a unique installation path instead of a hardcoded installation path for the one or more actions associated with the one or more software applications.

In some embodiments, the system analyzes the one or more actions across the one or more software applications (e.g., after implementation of the real-time execution of the one or more actions on the one or more entity systems), dynamically generates a weightage associated with the one or more actions based on analyzing the one or more actions across the one or more software applications, and assigns the weightage to the DNFCT based smart contract corresponding to the one or more actions. In some embodiments, the system identifies other entity applications having similar characteristics of the one or more software applications and recommends the one or more actions for the other entity applications based on the weightage assigned to the DNFCT based smart contract corresponding to the one or more actions. In some embodiments, the system may generate the weightage based on one or more parameters associated with the one or more actions, wherein the one or more parameters comprise at least technology information, program code, and performance information associated with the one or more actions.

FIG. 6 provides a block diagram illustrating multiple layers of a self-secured multi-layer intelligent operating system for the entity systems 200 provided by the automatic application installation and patching system 300 for automatically controlling installation and patching of the software applications in the entity systems 200, in accordance with an embodiment of the invention. As shown, the self-secured multi-layer intelligent operating system may comprise a base operating system 610, the base models 620, the background processors 630, and the one or more entity applications 270. The base operating system 610 may be an existing operating system which may comprise hardware and/or software components including but not limited to Kernel, memory, shell, and/or the like. The base models 620 may comprise an exposure assessment model 621 for assessing exposures (e.g., vulnerabilities) identified based on other base models, a security model 622 for assessing security associated with the entity system 200, a misappropriation detection model 623 for detecting misappropriations or exposures encountered by the entity system 200, a compliance model 624 for ensuring that the entity system 200 is in compliance with one or more compliance rules/standards set by governing entities or the entity associated with the entity system 200. The background processors 630 may comprise a system health monitor 631 for monitoring the health of the one or more components of the entity system 200, a proactive auto-shutdown processor 632 for automatically shutting down or suspending applications, services, or even the entire entity system 200 based on predefined conditions, an interdisciplinary collaboration processor 633 for ensuring communication between different components or base models 620 (e.g., communication between the exposure assessment model 621, the security model 622, and misappropriation detection model 623, and the compliance model 624), a software controller 634 for controlling the one or more software applications associated with the entity system 200, a patch validator for validating one or more patches (to be executed on the entity systems that are deemed necessary based on security vulnerabilities, etc.), an auto-installer 635 for automatically installing the patches or software applications on the entity system 200 (where the auto-installer 635 may be responsible for dynamic generation of containers for implementation of the real-time execution of the one or more actions which may comprise installation of a software application or a patch), and an auto-uninstaller for automatically uninstalling the patches or software applications on the entity system 200. The one or more entity applications 270 may be the one or more software applications that are managed by the background processors 630 based on the information in the analysis provided by the base models 620.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for automatically controlling installation and patching of software applications, the system comprising:
at least one network communication interface;
at least one non-transitory storage device; and
at least one processing device coupled to the at least one non-transitory storage device and the at least one network communication interface, wherein the at least one processing device is configured to:
collect data associated with one or more software applications associated with an entity that are installed on one or more entity systems;
analyze the data associated with the one or more software applications to determine one or more actions;
execute the one or more actions in one or more containers;
determine that the one or more actions result in optimization of the one or more entity systems;
validate implementation of real-time execution of the one or more actions on the one or more entity systems;
determine that the validation associated with the implementation of the real-time execution of the one or more actions on the one or more entity systems is successful;
in response to successfully validating the implementation of the real-time execution of the one or more actions in real-time, generate a Decentralized Non-Fungible Core Token (DNFCT) based smart contract for implementation of the real-time execution associated with each of the one or more actions; and
implement the real-time execution of the one or more actions on the one or more entity systems based on the DNFCT based smart contract.

2. The system of claim 1, wherein the at least one processing device is configured to:
analyze the one or more actions across the one or more software applications;
dynamically generate a weightage associated with the one or more actions based on analyzing the one or more actions across the one or more software applications; and
assign the weightage to the DNFCT based smart contract corresponding to the one or more actions.

3. The system of claim 2, wherein the at least one processing device is configured to:
identify other entity applications having similar characteristics of the one or more software applications; and
recommend the one or more actions for the other entity applications based on the weightage assigned to the DNFCT based smart contract corresponding to the one or more actions.

4. The system of claim 2, wherein the at least one processing device is configured to generate the weightage based on one or more parameters associated with the one or more actions, wherein the one or more parameters comprise at least technology information, program code, and performance information associated with the one or more actions.

5. The system of claim 1, wherein the DNFCT based smart contract comprises one or more rules associated with the implementation of the real-time execution of the one or more actions on the one or more entity systems.

6. The system of claim 1, wherein validating the implementation of the real-time execution of the one or more actions on the one or more entity systems comprises implementing a consensus mechanism by:
communicating with a plurality of validators associated with the one or more entity systems to provide a decision associated with the implementation of the real-time execution of the one or more actions on the one or more entity systems;
receiving a plurality of decisions from the plurality of validators; and
validating the implementation of the real-time execution of the one or more actions on the one or more entity systems based on the plurality of decisions.

7. The system of claim 1, wherein the consensus mechanism is a Federated Byzantine Agreement (FBA).

8. The system of claim 1, wherein the one or more actions comprise at least one of:
installation of a latest patch associated with the one or more software applications;
uninstallation of a previously installed patch associated with the one or more software applications;
uninstallation of the one or more software applications; and
installation of a new software application.

9. The system of claim 1, wherein the data associated with the one or more entity applications comprises at least installed software applications, package versions, system libraries, and security patches.

10. A computer program product for automatically controlling installation and patching of software applications, the computer program product comprising a non-transitory computer-readable storage medium having computer executable instructions for causing a computer processor to perform the steps of:
collecting data associated with one or more software applications associated with an entity that are installed on one or more entity systems;
analyzing the data associated with the one or more software applications to determine one or more actions;
executing the one or more actions in one or more containers;
determining that the one or more actions result in optimization of the one or more entity systems;
validating implementation of real-time execution of the one or more actions on the one or more entity systems;
determining that the validation associated with the implementation of the real-time execution of the one or more actions on the one or more entity systems is successful;
in response to successfully validating the implementation of the real-time execution of the one or more actions in real-time, generating a Decentralized Non-Fungible Core Token (DNFCT) based smart contract for implementation of the real-time execution associated with each of the one or more actions; and
implementing the real-time execution of the one or more actions on the one or more entity systems based on the DNFCT based smart contract.

11. The computer program product of claim 10, wherein the computer executable instructions for causing the computer processor to perform the steps of:
analyzing the one or more actions across the one or more software applications;
dynamically generating a weightage associated with the one or more actions based on analyzing the one or more actions across the one or more software applications; and
assigning the weightage to the DNFCT based smart contract corresponding to the one or more actions.

12. The computer program product of claim 11, wherein the computer executable instructions for causing the computer processor to perform the steps of:
identifying other entity applications having similar characteristics of the one or more software applications; and
recommending the one or more actions for the other entity applications based on the weightage assigned to the DNFCT based smart contract corresponding to the one or more actions.

13. The computer program product of claim 10, wherein validating the implementation of the real-time execution of the one or more actions on the one or more entity systems comprises implementing a consensus mechanism by:
communicating with a plurality of validators associated with the one or more entity systems to provide a decision associated with the implementation of the real-time execution of the one or more actions on the one or more entity systems;
receiving a plurality of decisions from the plurality of validators; and
validating the implementation of the real-time execution of the one or more actions on the one or more entity systems based on the plurality of decisions.

14. The computer program product of claim 10, wherein the one or more actions comprise at least one of:
installation of a latest patch associated with the one or more software applications;
uninstallation of a previously installed patch associated with the one or more software applications;
uninstallation of the one or more software applications; and
installation of a new software application.

15. The computer program product of claim 10, wherein the DNFCT based smart contract comprises one or more rules associated with the implementation of the real-time execution of the one or more actions on the one or more entity systems.

16. A computer implemented method for automatically controlling installation and patching of software applications, wherein the method comprises:
collecting data associated with one or more software applications associated with an entity that are installed on one or more entity systems;
analyzing the data associated with the one or more software applications to determine one or more actions;
executing the one or more actions in one or more containers;
determining that the one or more actions result in optimization of the one or more entity systems;
validating implementation of real-time execution of the one or more actions on the one or more entity systems;
determining that the validation associated with the implementation of the real-time execution of the one or more actions on the one or more entity systems is successful;
in response to successfully validating the implementation of the real-time execution of the one or more actions in real-time, generating a Decentralized Non-Fungible Core Token (DNFCT) based smart contract for implementation of the real-time execution associated with each of the one or more actions; and
implementing the real-time execution of the one or more actions on the one or more entity systems based on the DNFCT based smart contract.

17. The computer implemented method of claim 16, wherein the method comprises:
analyzing the one or more actions across the one or more software applications;
dynamically generating a weightage associated with the one or more actions based on analyzing the one or more actions across the one or more software applications; and
assigning the weightage to the DNFCT based smart contract corresponding to the one or more actions.

18. The computer implemented method of claim 17, wherein the method comprises:
identifying other entity applications having similar characteristics of the one or more software applications; and
recommending the one or more actions for the other entity applications based on the weightage assigned to the DNFCT based smart contract corresponding to the one or more actions.

19. The computer implemented method of claim 16, wherein validating the implementation of the real-time execution of the one or more actions on the one or more entity systems comprises implementing a consensus mechanism by:
communicating with a plurality of validators associated with the one or more entity systems to provide a decision associated with the implementation of the real-time execution of the one or more actions on the one or more entity systems;
receiving a plurality of decisions from the plurality of validators; and
validating the implementation of the real-time execution of the one or more actions on the one or more entity systems based on the plurality of decisions.

20. The computer implemented method of claim 16, wherein the one or more actions comprise at least one of:
installation of a latest patch associated with the one or more software applications;
uninstallation of a previously installed patch associated with the one or more software applications;
uninstallation of the one or more software applications; and
installation of a new software application.
